(19) United States
(12) Patent Application Publication
(10) Pub. No.: US 2010/0057569 A1
(43) Pub. Date: Mar. 4, 2010

(54) Advertising System for Internet Discussion Forums

(76) Inventors: Nathan Cantelmo, Synnyvale, CA (US); Alexandros Giamas, Mountain View, CA (US); Gunther Hagleitner, San Jose, CA (US)

Correspondence Address: Stattler-Suh PC, 60 SOUTH MARKET, SUITE 480, SAN JOSE, CA, 95113, US

(21) Appl. No.: 12/201,540

(22) Filed: Aug. 29, 2008

(51) Int. Cl. G06Q 30/00

(52) U.S. Cl. 705/14.55

(57) ABSTRACT

This patent discloses a system to display an online advertisement to a user viewing user-generated comments in an online discussion forum. The system may include an ad server having online advertisements in an ad database. The ad server may include an analyzer to compare compiled metadata to at least two of the online advertisements. The compiled metadata may include metadata from the user-generated comment. The comparison may result in the selection of one advertisement for display with the user-generated comment. The selected advertisement may be called a paired advertisement and the ad server further may serve the paired advertisement to the user-generated comment.

### BACKGROUND

1. Field

The information disclosed in this patent relates to displaying contextually relevant advertisements adjacent to user-generated comments in an online discussion forum.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

One area largely untapped by Internet advertisers is user-generated comments in online discussion forums, such as blogs, general discussion sites, and specialty discussion sites. In June 2008, Technorati, an Internet search engine for searching blogs, reported finding an average of 1.6 million unique blog commentary entries being posted each day. These blog commentary entries receive multiple user-generated comments and millions of page views each day. When the massive amount of user-generated comments on popular social news websites, technology-related news websites, content sharing sites, and the many topic-specific forums in existence for niche groups such as car owners, aspiring chefs, and minor investors are added to the blog-generated posts, the enormous advertising potential for this segment of the Internet begins to come into focus.

The lack of effort on the part of advertisers and their partners to enter into this area of huge business opportunity is due to the difficulties in making such a system work. What is needed is a system to address these and other issues.

### SUMMARY

This patent discloses a system to display an online advertisement to a user viewing user-generated comments in an online discussion forum. The system may include an ad server having online advertisements in an ad database. The ad server may include an analyzer to compare compiled metadata to at least two of the online advertisements. The compiled metadata may include metadata from the user-generated comment. The comparison may result in the selection of one advertisement for display with the user-generated comment. The selected advertisement may be called a paired advertisement and the ad server further may serve the paired advertisement to the user-generated comment.

### BRIEF DESCRIPTION OF THE FIGURES

FIG. 1 is a block diagram illustrating a system 100.

FIG. 2 is an example layout of discussion webpage 104.

FIG. 3 is a block diagram illustrating a system 300.

FIG. 4 is a method 400 to display online advertisement 102 to user 10.

FIG. 5 illustrates a network environment 500 for operation of system 100.

### DETAILED DESCRIPTION

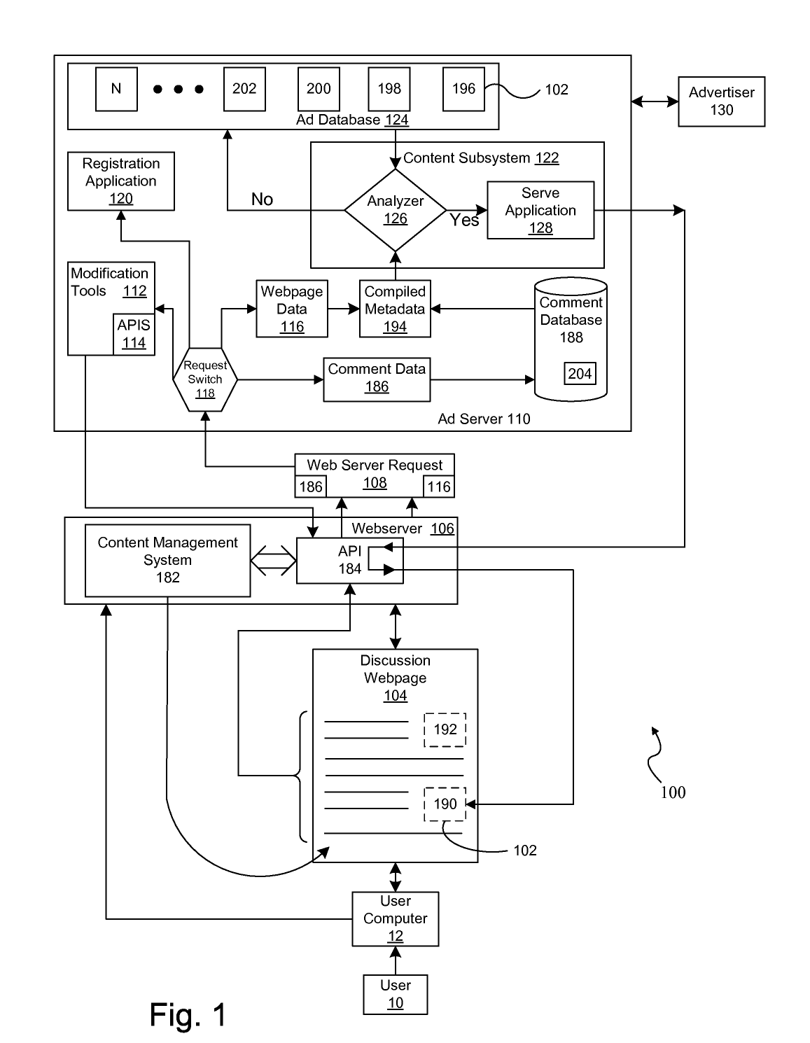

FIG. 1 is a block diagram illustrating a system 100. System 100 may be a group of independent but interrelated elements that may work to place an advertisement 102 on discussion webpage 104 for viewing by a user 10. Each placed advertisement 102 may be relevant to and connected with a pre-selected user-generated comment in a discussion on discussion webpage 104. Online discussion forums such as discussion webpage 104 represent an enormous advertising potential. In addition to the sheer quantity of advertising opportunities in blogs, news websites, and content sharing website, system 100 may reach into advertising-free websites such as Wikipedia®, which prohibits advertising on any of its article pages but may be inclined to add revenue-generating advertisements on its millions of user discussion pages. Additionally, system 100 may provide a strategic way of posting advertisements on webpages already having advertisements, such as at Amazon.com® where the advertisements remain outside of and not directly connected with the numerous product user reviews posted on that site. Importantly, system 100 may monetize assets by adapting previously non-revenue-generating assets into those that generate revenue.

In operation, user 10 may engage a user computer 12 to request that a particular discussion webpage 104 be displayed on user computer 12. The request from user 10 may be sent to a web server 106 via user computer 12. Web server 106 may be hosting a website that may include many webpages, including discussion webpage 104. To fund this hosting service, web server 106 may seek out advertisements that may bring in revenue when clicked on by user 10.

On receiving the request from user 10, web server 106 may send its own request, here, a web server request 108, to an ad server 110. Web server request 108 may include webpage data 116 and a request for ad server 110 to provide one or more advertisements for display on discussion webpage 104. In response, ad server 110 may return an online advertisement 102 to web server 106 for display in the discussion webpage 104 requested by user 10.

In addition to physically pairing together an advertisement and a user-generated comment in an online discussion, system 100 may work to ensure that the paired advertisement may be contextually relevant to the user-generated comment and have some relevance to the particular user 10 viewing the advertisement. To aid in this, system 100 additionally may include modification tools 112 having Application Programming Interfaces (API) 114 for distribution to web servers such as web server 106. In addition, system 100 further may include a request switch 118, a registration application 120, a content subsystem 122, and an ad database 124. The content subsystem 122 may include an analyzer 126 and a serve application 128. Request switch 118 may be connected between web server 106 and modification tools 112, registration application 120, and content subsystem 122. In addition to being connected to request switch 118, content subsystem 122 may be connected between ad database 124 and web server 106. Modification tools 112 may be connected to web server 106 as well. Connected to an item may mean configured to be in communication with a particular item.

Advertisement 102 may be an announcement called to the attention of the public 10. For example, advertisement 102 may include an announcement to make something known, especially to persuade people 10 to buy whatever is advertised. Advertisement 102 may be a communication to inform potential customers 10 about products and services, about how to obtain them, and use them.

When displayed on an Internet webpage, advertisement 102 may be an online advertisement. As display advertising-content appearing on a webpage, advertisement 102 may be in a form such as text, a banner, a half banner, a streaming banner, a button, an interactive button ad, a clickable ad, mail, raw text, a rectangle, or a skyscraper and may range in size from 25×25 to 728×210, for example. Advertisement 102 may be in other sizes or ad forms. In one example, advertisement 102 may be formatted and served as a small, text-only box. Table I below includes example text in an advertisement 102:

TABLE I

Advertisement:
Credit Loans
Great Low Rate Mortgage Loans. Apply Now
for Rapid Response,
www.tindaleloan.com

In one example, the text-only boxes may measure approximately 2-inches by ⅝-inch and have five or fewer lines of text. Text for the text-only boxes' advertisements may be received by ad server 110 from advertisers 130 (FIG. 1) and other sources. Advertisers 130 may be one of four stakeholders of system 100, with the other three that may have an interest in the success of system 100 being ad service provider 110, third-party website owners 106, and third-party website users 10.

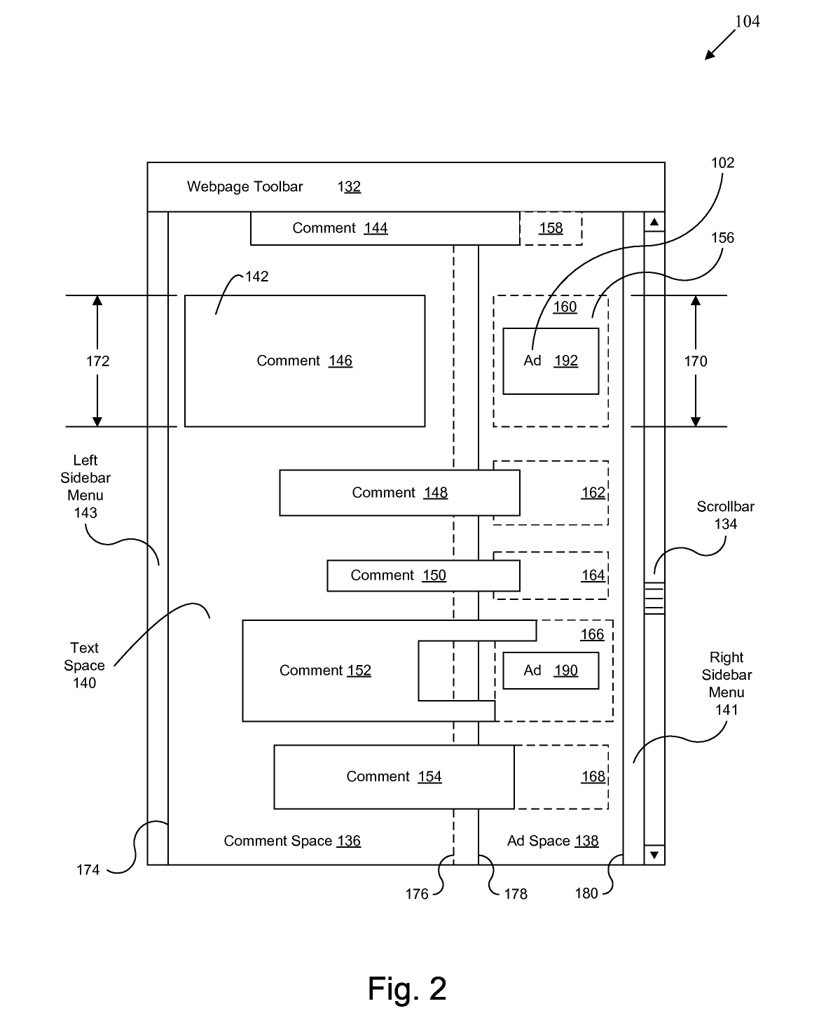

FIG. 2 is an example layout of discussion webpage 104. Discussion webpage 104 may be a resource of information in web server 106 accessed through a web browser. A web browser may include a software application that may enable user 10 to display and interact with text, images, videos, music, and other information located on discussion webpage 104. The information may be in a HyperText Markup Language (HTML) format or Extensible Hypertext Markup Language (XHTML) format. Discussion webpage 104 may provide navigation to other webpages through advertisement 102 and hypertext links.

Discussion webpage 104 may include any webpage configured to contain a user-generated comment. Discussion webpage 104 typically may have multiple user-generated comments but needs only one user-generated comment to be a discussion webpage. The user-generated comment need not be in response to something. For example, the user-generated comment may be the first user-generated comment posted to the discussion webpage 104 and may be served an advertisement 102 at the time of first being posted.

Discussion webpage 104 may be arranged into areas such as a webpage toolbar 132, a scrollbar 134, a comment space 136, and an advertisement space 138 positioned adjacent to comment space 136. Advertisement space 138 may be positioned to the left or right of comment space 136. However, advertisement space 138 may be positioned at other adjacent locations with respect to comment space 136. In one example, comment space 136 and advertisement space 138 may touch one another. In another example, comment space 136 and advertisement space 138 may be near or close to but not necessarily touching each other and any intervening space typically may lack content. In a further example, some parts of comment space 136 and advertisement space 138 may touch one another and other parts may be close to but not necessarily touching each other.

Discussion webpage 104 additionally may include a text space 140. Comment space 136 and advertisement space 138 may be positioned inside text space 140 and webpage toolbar 132 and scrollbar 134 may be positioned outside of text space 140. Text space 140 may be a visual area on discussion webpage 104 where user 10 may view user-generated comments 142 and text from advertisements 102. Comment space 136 and advertisement space 138 each may be text-receiving and -displaying columns that may be continuous in a vertical direction well beyond a vertical visible boundary provided by text space 140.

Between scrollbar 134 and text space 140/advertisement space 138 may be one or more columns, such as a right sidebar menu 141. Right sidebar menu 141 may include a list of pages, categories, archives, calendar, and dates as part of a navigation panel that people may use to move around the website to which discussion webpage 104 belongs. In an example, discussion webpage 104 may include a left sidebar menu 143 to the left of text space 140/comment space 136. Right sidebar menu 141 and left sidebar menu 143 may be positioned outside of text space 140.

Right sidebar menu 141 also may include advertisements. Typically, these advertisements may reside near the top of discussion webpage 104 and not extend too far down the page. In a lengthy text discussion on discussion webpage 104, those posts made closer to the present time may be near the bottom of discussion webpage 104. To see these posts, user 10 likely will scroll down to near the bottom of discussion webpage 104 so that any right sidebar menu 141 advertisements no longer are visible on the monitor of user 10. Users cannot click on advertisements they cannot see on their monitor. In comparison, system 100 may predict which user-generated comments 142 a given user 10 is likely to read and position advertisements 102 next to those user-generated comments 142 having a greater chance of being seen by user 10. Here, an advantage of system 100 is that system 100 may not be dependent upon the predetermined layout of discussion webpage 104 external to text space 140, but rather may be flexible enough to position advertisements 102 as a function of the growth of the text discussion on discussion webpage 104.

Webpage toolbar 132 may be a panel having tabs, onscreen buttons, icons, menus, and other elements that may engage web server 106 or user computer 12 with input or output. The input/output may affect discussion webpage 104. Scrollbar 134 may be a graphical device with which user 10 may move the contents within text space 140 up and down. This may aid user 10 in revealing any continuous text that may not fit immediately into the visible space provided by text space 140.

Comment space 136 may include user-generated comments 142, such as user-generated comment 144, 146, 148, 150, 152, and 154. User-generated comments 142 may be text content available over the Internet and produced by end-users and consumers such as user 10. Each user-generated comment 142 may be a posting by one user 10. User-generated comments 142 may be messages that may express a personal opinion or belief and/or add information. User-generated comment 142 may be part of an extended communication dealing with some particular topic. For example, multiple user-generated comments 142 may be part of an exchange of views by different individuals 10 on a particular automobile.

Messages within comment space 136 typically may be displayed as a threaded discussion. A threaded discussion may aid user 10 by visually grouping messages in a hierarchy by topic, in chronological order. A set of messages grouped in this way may be referred to as a topic thread or simply “thread” and the discussion may be referred to as being set in thread mode. Usually, each user-generated comment 142 may have a topical relationship with other user-generated comments 142 in the same message grouping. For example, if one user addresses mortgage loans through a post, other users may also address mortgage loans within that same thread. Threaded discussions may allow user 10 to reply to particular posting within a topic's thread. As a result, there may be a hierarchy of discussions within the thread topic. The left justification of each user-generated comment 142 may be varied to provide an indication as to which existing comment the message may be directed.

Alternatively, messages within comment space 136 may be displayed in linear mode, where all of the posts may be displayed in date order, regardless of who may have specifically replied to whom. For blogs, there may be only one message grouping and that grouping may be listed in chronological order. As more messages are posted in either thread mode or linear mode, the length of user-generated comments 142 within a discussion webpage 104 may grow, usually downward.

Advertisement space 138 may include advertisement positions 156, such as advertisement position 158, 160, 162, 164, 166, and 168. Advertisement positions 156 may be discrete areas within advertisement space 138 configured to receive one or more advertisements 102. In other words, each advertisement position 156 may be a particular portion of space configured to be occupied by one, two, three or more advertisements 102. There may be one advertisement position 156 for each user-generated comment 142. In an example, only some of the advertisement positions 156 will include an advertisement 102 and the remainder may remain empty of an advertisement 102. Ad server 110 may make a decision as to which advertisement positions 156 should be filled and which should remain empty.

Each advertisement position 156 may have an advertisement space height 170. In addition, each user-generated comment 142 may have a comment height 172 based at least on the amount of lines used to post the words of the comment in comment space 136. For example, a ten word user-generated comment 142 may have a comment height 172 of at least a single line where as a two hundred word user-generated comment 142 may have a comment height 172 of five lines. In an example, comment height 172 may be based on all information included with a user's post, including the user name, date and time of the post, and dynamic links such as permalink, parent, and reply. Comment height 172 may include content empty space above and/or below the text of a user-generated comment 142.

Advertisement space height 170 and comment height 172 may be a function of each other such as when user-generated comment 142 and advertisement 102 are aligned next to each other. For example, when comment height 172 is greater than a height of advertisement 102, advertisement space height 170 may expand to be equal to comment height 172 and thus be greater than the height of advertisement 102. Using user-generated comment 146 (FIG. 2) and advertisement position 160 as an example, a paired advertisement 192 may be placed at several vertical positions within advertisement space 160 relative to user-generated comment 146. When comment height 172 is less than a height of advertisement 102, comment height 172 may expand to be equal to advertisement space height 170, such as when a paired advertisement 190 is located within advertisement position 166.

Comment space 136 may include a comment space left side 174 and a comment space right side 176. Advertisement space 138 may include an advertisement space left side 178 and an advertisement space right side 180. Comment space left side 174, advertisement space left side 178, and advertisement space right side 180 may be fixed and provide horizontal bounds for user-generated comments 142 and advertisements 102, respectively. When an advertisement 102 is horizontally paired with a particular user generated comment 142 and inserted into an advertisement position 156, part or all of the user-generated comment 142 associated with that advertisement position 156 may be bound by comment space right side 176. This may prevent user-generated comment 142 from overlapping its advertisement 102 partner. An example of this is user-generated comment 152 (FIG. 2) in which part of user-generated comment 152 may extend into advertisement space 138 and part may be restricted by comment space right side 176. If part or all of advertisement position 156 does not include advertisement 102, then comment 142 may expand beyond comment space right side 176 and overlay its associated advertisement position 156.

As noted above, text space 140 may be a visual area on discussion webpage 104 where user 10 may view user-generated comments 142 and text from advertisement 102. In an example, text space 140 may comprise only comment space 136, its contents, advertisement space 138, and its contents. Text space 140 may be controlled by a content management system 182 (FIG. 1).

Content management system 182 may include discussion software that may be used to organize and facilitate collaborative content creation within text space 140. Content management system 182 may include a web application to receive and post user-generated comments 142 that may appear on discussion webpage 104. Content management system 182 may allow people to hold discussions in an online forum, such as blogs, Internet forums, Web forums, newsgroups, message boards, discussion boards, electronic discussion groups, discussion forums, bulletin boards, and fora. Examples of content management system 182 may include, but are not limited to, WordPress®, Drupal®, and Windows SharePoint Services®. Content management system 182 may be thought of as a discussion content management system. Areas within discussion webpage 104 and outside of text space 140 typically may be controlled by a management system other than content management system 182. Here, content management system 182 may lack direct control of those areas of discussion webpage 104 that may be outside of text space 140.

As noted above, system 100 may include web server 106 (FIG. 1). Web server 106 may include a web server computer program to accept HTTP requests from user computer 12 and to serve an HTTP response along with optional data content to user computer 12. Web server 106 may include both content management system 182 and a computer that runs the web server computer program. Web server 106 may construct (X)HTML for each discussion webpage 104 when it is requested by a user computer 12.

Web server request 108 may be a message sent to ad server 110 that may request something, such a modification tool from modification tools 112, registration through registration application 120, or one or more advertisements 102 for display on discussion webpage 104. When requesting advertisements 102 for display on discussion webpage 104, web server request 108 may include webpage data 116. Webpage data 116 may include information about user 10, such as the identity (e.g., name, age, gender) and geographic location of user 10, the date, time, and location of the webpage request from user 10, and metadata characterizing the particular discussion webpage 104 requested.

Ad server 110 may include a computer server, such as a web server, that may store advertisements 102 used in online marketing and may deliver them to website visitors 10. Ad server 110 may update the contents of web server 106 so that the website or webpage on which the advertisements are displayed may contain new advertisements 102. In addition, ad server 110 may perform various other tasks such as counting the number of impressions, clicks, and conversions for an ad campaign and report generation. Ad server 110 may include tools to track and monetize user clicks and ad impressions on third-party websites, such as those that may be hosted by web server 106. Ad server 110 may be a local ad server run by a single publisher and serve advertisements to that publisher's domains or may be a third party, remote ad server that may serve advertisements across domains that may be owned by multiple publishers.

Modification tools 112 may be a collection of tools to modify discussion platforms automatically to interface with system 100. Application Programming Interfaces (API) 114 may be part of modification tools 12. For many web servers 106 using popular discussion platforms such as WordPress®, tools from modification tools 112 may be bundled into an easy-to-install package that may fully integrate web servers 106 with API 14. For non-supported or non-standard websites, modification tools 112 may include short, reusable pieces of computer source code (such as JavaScript® snippets) that may allow a website owner to modify the software running their discussion webpages to work with API 114. In turn, API 114 may operate to provide much of the communication between web server 106 and ad server 110. In other words, API 114 may act as an agent for ad server 110, where API 114 resides in web server 106.

API 114 may be software that may include a set of declarations of the functions (or procedures) distributed by ad server 110 to support requests made by web server 106. Web server 106 may initially send a request to ad server 110 to retrieve its copy of API 114. For purposes of discussion, the copy of the API installed in web server 106 is designated in FIG. 1 as API 184. APIs 114 and API 184 may function similarly. Once installed on web server 106, API 184 may be in communication with ad server 110 and content management system 182. Control over text space 140 may be a collaborative software effort between content management system 182 and API 184.

API 184 may serve in a number of different roles that may affect the overall performance of system 100 on discussion webpage 104. API 184 may be used to delimit the start point and end point of each user-generated comment 142 and the comment section of comment space 136. API 184 may capture and forward information on per-comment traffic and/or ratings, where applicable. In addition, API 184 may capture and forward new or edited user-generated comments 142 to ad server 110 as users 10 post each comment or in response to a predetermined event. API 184 may forward user-generated comments 142 to ad server 110 as comment data 186. Comment data 186 may be sent as part of web server request 108 and be stored in comment database 188 on receipt by ad server 110. In an example, ad server 110 may send out crawlers to web server 106 to retrieve new user-generated comments 142 for storage in comment database 188.

API 184 additionally may position a contextually relevant advertisement 102 aside a preselected user-generated comment 142. Examples of contextually relevant advertisements 102 may include paired advertisement 190 and paired advertisement 192. Further, API 184 may provide some level of customization over the appearance of text window 136 to accommodate different discussion site layouts. Layout customization may be a task for which owners of discussion webpage 104 may have final responsibility, provided that the owners meet any regulations provided by ad server 110 and advertiser 130.

Request switch 118 may be a device in ad server 110 that receives and initially processes web server request 108. Request switch 118 may send tool requests to modification tools 112, send webpage data 116 to compiled metadata 194, and send comment data 186 to comment database 188. In addition, request switch 118 may send registration requests to registration application 120.

The ad service provider may or may not have a prior ad-serving arrangement with third-party website owners. If not, then web server 106 may need to register with ad server 110 through registration application 120 to access services of system 100. Registration application 120 may be a front-end for third-party website owners to register their site with the system 100. The ad provider that controls ad server 110 may host registration application 120. Registration application 120 may include computer software to receive enrollment information from web server 106. On registering, web server 106 may receive an identification string that may uniquely identify web server 106 to ad server 110. To access services provided by ad server 110, web server 106 may send the identification to ad server 110 with each web server request 108.

Ad database 124 may have a plurality of advertisements 102, including advertisements 196, 198, 200, 202, through advertisement N. The owner of ad server 110 may be partnered with a number of advertisers 130 and, as such, may hold a substantial inventory of advertisements 102 in ad database 124. In an example, advertisements from this inventory may be formatted and served as small, text-only boxes, such as in Table I above. Ad database 124 may be a structured collection of records. Each record may be an advertisement object 102 having a list of tags that may characterize the advertisement.

Content subsystem 122 may be a backend system to analyze user-generated comments 142 received from discussion webpage 104. In addition, content subsystem 122 may serve contextually relevant advertisements 102 to discussion webpage 104. As noted above, content subsystem 122 may include analyzer 126 and serve application 128.

Analyzer 126 may be a device that analyzes given data. Analyzer 126 may examine in detail the structure of the given data to find patterns and relationships between parts of the data. Analyzer 126 may be a piece of hardware or a software program running on a computer and may include an arithmetic logic unit as a digital circuit that performs arithmetic and logical operations. Analyzer 126 may include software to (i) select a user-generated comment 142 for potential advertisement placement, (ii) perform metadata extraction on comment data 186, (iii) contextually match compiled metadata 194 to an advertisement 102 for each user-generated comment 142 selected at (i), and (iv) determine which of the matched advertisements 102 to provide to discussion webpage 104.

Select a User-Generated Comment 142 for Potential Advertisement Placement

User-generated comments 142 may come in a variety of forms, including the short character, smiley face emoticon “:-)”, garbled text, and images. Some user-generated comments 142 may make better candidates to receive a partner advertisement 102 than others. For a given set of user-generated comments 142, some may make bad candidates and may be screened out from further processing. Analyzer 126 may evaluate each user-generated comment 142 received into comment database 188 for its suitability to receive a partner advertisement 102. As each new user-generated comment 142 is received into comment database 188, analyzer 142 may reevaluate previously evaluated user-generated comment 142 in the context of the new user-generated comment 142.

Evaluating each user-generated comment 142 received into comment database 188 for its suitability to receive a partner advertisement 102 may include the use of weighted factors, for example. Each user-generated comment 142 within discussion webpage 104 may be weighted against other user-generated comment 142 within discussion webpage 104 and receive a first weighted value. The first weighted value may be a number assigned to the weighted user-generated comment 142 adjusted to reflect value or proportion relative to other user-generated comment 142 within discussion webpage 104. In addition, user-generated comments 142 within a give thread (if any) may be weighted against other comments in that thread to receive a second weighted value. For each user-generated comment 142, the weighting process may take into account a variety of factors, including the number of characters used for that comment (e.g., its length), the amount of terms extracted from that comment, the relevancy of the terms extracted from that comment to other comments, the number of replies to that comment, the posting date of that comment, the relative dates of the replies to that comment, the position of that comment on web page 104, and the number of named entities. In addition, financial considerations such as costs-per-click (CPC) and click-through-rates (CTR) may be considered in the evaluation.

Metadata Extraction on Comment Data 186

As noted above, comment data 186 may be sent as part of web server request 108 and be stored in comment database 188 on receipt by ad server 110. Once received into comment database 188, analyzer 126 may further reduce and focus comment data 186. For example, analyzer 126 may extract out a list of significant/relevant words or phrases from comment data 186, such as non-generic noun phrases. Here, each user-generated comment 142 may be characterized by a vocabulary of relevant terms, constituting a linguistic surface manifestation of concepts in a given user-generated comment 142. Ad server 110 may utilize this information to select a contextually relevant advertisement 102 for display alongside a selected user-generated comment 142. An example key-term extractor that may be utilized for this is the Term Extraction Web Service, provided by Internet services provider Yahoo!® at http://developer.yahoo.com/search/content/V1/termExtraction.html.

Contextually Match Compiled Metadata 194 to an Advertisement 102

Ad server 110 may be an ad-targeting content-analysis system for user-generated comments 146. Ad server 110 may be in communication with an ad database 124 and compiled metadata 194. Metadata may be data about data. Compiled metadata 194 may be a combination of webpage data 116 and metadata from a user-generated comment 142 pre-selected for potential advertisement placement. Compiled metadata 194 may include metadatadata from a plurality of user-generated comments 142. As noted above, webpage data 116 may include information about user 10, such as the identity (e.g., name, age, gender) and geographic location of user 10, the date, time, and location of the webpage request from user 10, and metadata characterizing the particular discussion webpage 104 requested. Such personal information may aid in better matching an advertisement 102 to the user-generated comment 142 pre-selected for potential advertisement placement in the context of webpage data 16. In other words, taking webpage data 116 into account when matching an advertisement 102 to the pre-selected user-generated comment 142 may increase the likelihood that user 10 will click through the matched advertisement 102.

Compiled metadata 194 may include previously compiled clicks and ad impressions of user 10 and utilize that information in the comparison. Compiled metadata 194 also may include lifestreaming data of user 10. Lifestreaming data may be a collection of terms representing activities of user 10 on websites throughout the Internet, including websites not hosted by web server 106 and ad server 110. The use of lifestreaming data may allow system 100 to personalize an advertisement for each individual user 10 to increase the click through revenue rate.

Ad server 110 may use analyzer 126 to compare compiled metadata 194 with each set of tags that may characterize each advertisement 102. In other words, an online advertisement 102 may be selected by comparing one or more user-generated comments 142 and/or webpage data 116 to advertisements 102 in ad database 124. Analyzer 126 may determine whether there may be a match between compiled metadata 194 and an advertisement 102. If a particular advertisement 102 is a closest match to compiled metadata 194, then analyzer 126 may determine that that advertisement 102 is a most relevant advertisement to a given user-generated comment 142 and/or to user 10 under the circumstances. The given user-generated comment 142 and selected, contextually relevant advertisement 102 may be paired for potential display on web page 104.

Determine Which of the Paired Advertisements 102 to Provide to Discussion Webpage 104.

A goal of placing advertisements is to position the ad in a location where it may have the greatest chance of receiving a click through from a given user 10. While using one advertisement 102 for each user-generated comment 142 may cover all advertisement positions 156 on web page 104, excessive placement of advertisements may overwhelm a user to a point where they decide not to click through on any advertisement. At least one advertisement 102 should come into the view of user 10 while viewing and scrolling web page 104. Placing more than one advertisement 102 in advertising space 138 may increase a likelihood of at least one advertisement 102 coming into the view of user 10 while viewing and scrolling web page 104.

The determination by analyzer 126 as to which of the paired advertisements 102 to provide to discussion webpage 104 may be based on a variety factors. The evaluation may take into account information about user 10 from webpage data 116, information from comment space 136, such as whether user 10 has previously posted in comment space 136 and the number of named entities, and information about each user-generated comment 142 previously selected for potential advertisement placement.

In an experiment, a thread of twenty user-generated comments 142 was selected for analysis. It was predetermined that fifteen percent of the user-generated comments should receive at least one advertisement 102. In other words, three of the twenty user-generated comments 142 eventually would be partnered with an advertisement 102 and displayed together. A randomizing algorithm was used to determine the three partners. The algorithm was weighted towards longer comments. For example, between a first user-generated comment 142 having seventy words and a second user-generated comment 142 having thirty words, there may be a seventy percent chance that an advertisement 102 may end up partnered with first user-generated comments 142 and a thirty percent chance that an advertisement 102 may be partnered with second user-generated comments 142. Longer comments typically have more content, make more sense out of context, and contain more meaningful thoughts than shorter comments. Each of the twenty user-generated comments 142 received a weighted value based on the number of words in that comment. The randomizing algorithm ultimately selected three comment 142/advertisement 102 pairs to be served as part of the requested discussion webpage 104. The relevant advertisements 102 were preferentially placed on comments 142 with a higher number of named entities.

Many user-generated comments 142 are designed to remain in place for years on the same web page 104. If the same advertisement 102 may be served up to the same user-generated comment 142 each time, calls to ad server 110 may be cached. The cache may include a collection of data duplicating original values computed earlier and stored in an economical location. The cached calls may be used to determine which advertisements 102 should go with an old web page 104.

Serve application 128 may be an application to send advertisements 102 to web server 106 and help ensure that they are positioned in the predetermined advertisement positions 156. When a paired advertisement 102 is selected for display by analyzer 126, serve application 128 may serve advertisement 102 to API 184. In turn, API 184 may locate advertisement 102 into discussion webpage 104 for viewing by user 10 on user computer 12.

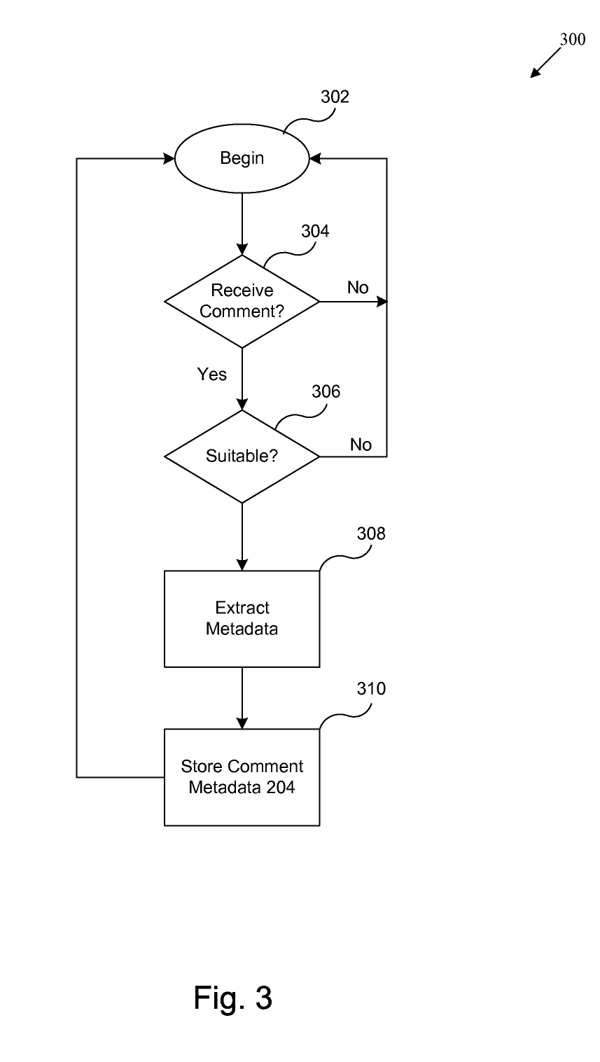

FIG. 3 is a block diagram illustrating a system 300. System 300 may be a group of independent but interrelated elements that may work to extract out and store metadata from user-generated comment 142. In addition, system 300 may determine whether user-generated comment 142 is suitable for an advertising partnership.

At step 302, system 300 may begin. At step 304, system 300 may determine whether ad server 119 has received a user-generated comment 142 from web server 106. If ad server 119 has not received a user-generated comment 142 from web server 106, then system 300 may return to step 302. If ad server 119 has received a user-generated comment 142 from web server 106, then system 300 may proceed to step 306.

At step 306, system 300 may determine whether user-generated comment 142 may be suitable for pairing with an advertisement 102. Evaluating each user-generated comment 142 received into comment database 188 for its suitability to receive a partner advertisement 102 may include the use of weighted factors, as described above. If user-generated comment 142 is not suitable for pairing with an advertisement 102, system 300 may return to step 302. If user-generated comment 142 is suitable for pairing with an advertisement 102, system 300 may proceed to step 308.

At step 308, system 300 may extract comment metadata 204 from user-generated comment 142. Comment metadata 204 may include metadata extracted out of comment data 186. At step 310, system 300 may store the extracted comment metadata 204 in comment database 188. From step 310, system 300 may return to step 302.

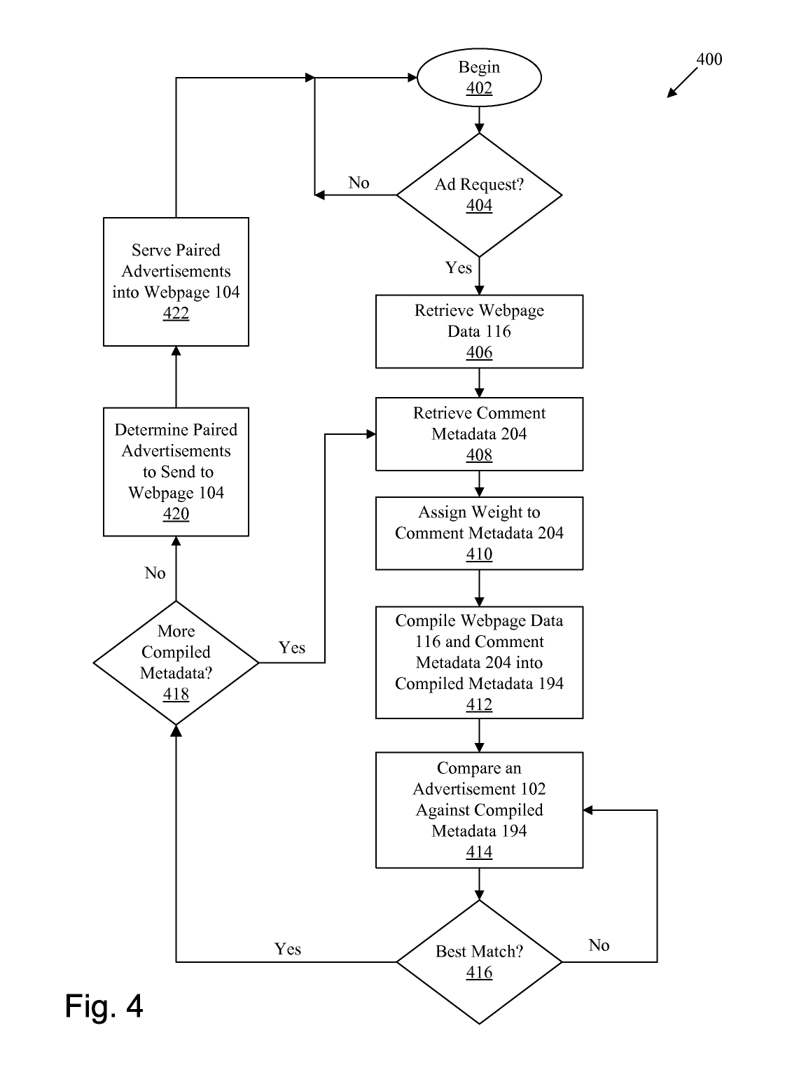

FIG. 4 is a method 400 to display online advertisement 102 to user 10. Method 400 may display online advertisement 102 adjacent to user-generated comment 142 within text space 140 on discussion webpage 104. Method 400 may work to select and display that advertisement which may be contextually relevant to user-generated comment 142, contextually relevant to user 10, and/or behaviorally relevant to user 10 (through lifestreaming data, for example). Method 400 may serve advertisement 102 to user-generated comment 142 by placing advertisement 102 aside user-generated comment 142 in text space 140.

At step 402, method 400 may begin. At step 404, method 400 may determine whether ad server 110 has received a request for advertisements from web server 106. For example, when user computer 12 requests display of discussion webpage 104 from a website hosted by web server 106, web server 106 may notify ad server 110 of this through web server request 108. A purpose of this is to display an advertisement 102 so that both the entities operating ad server 110 and web server 106 may share in the advertising revenue resulting from the advertisement display.

Webpage data 116 may be included with web server request 108. As noted above, webpage data 116 may include information about user 10, such as the identity (e.g., name, age, gender) and location of user 10, the date, time, and location of the web page request from user 10, and metadata characterizing the particular web page requested. If ad server 110 has not received a web server request 108 from web server 106, method 400 may return to step 402. If ad server 110 has received a web server request 108 from web server 106, then method 400 may proceed to step 406. At step 406, method 400 may retrieve webpage data 16.

At step 408, method 400 may retrieve comment metadata 204. There may be multiple items of comment metadata 204, each from a particular user-generated comment 142 (FIG. 2). Method 400 may retrieve one items of comment metadata 204 at a time for comparison with advertisements 102.

At step 410, system 100 may assign a weight to each piece of retrieved comment metadata 204 as a function of the metadata contained within webpage data 16. For example, if user 10 had included a term about a camera in posting a user-generated comment, such information may be included with the metadata contained within webpage data 116 and each piece of metadata within comment metadata 204 related to cameras may be given more weight than metadata not related to cameras. If the user-generated comment from user 10 included an indication that user 10 was looking to buy, rent, or window shop for cameras, then each piece of metadata within comment metadata 204 additionally may be weighted according to this information.

At step 412, method 400 may compile retrieved webpage data 116 and weighted comment metadata 204 into compiled metadata 194. At step 414, method 400 may compare compiled metadata 194 against an advertisement 102 in ad database 112. At step 416, system 100 may determine whether the compared advertisement is a best match to compiled metadata 194. This may include determining how many keywords associated with an online advertisement 102 match keywords contained in comment metadata 204. If the compared advertisement is not a best match to compiled metadata 194, then method 400 may return to step 414. If the compared advertisement is a best match to compiled metadata 194, then the advertisement may be deemed a paired advertisement 102 for the utilized user-generated comment 142 and method 400 may proceed to step 418.

At step 418, method 400 may determine whether there are any more user-generated comments 142 that lack a paired advertisement. If there are more user-generated comments 142 that lack a paired advertisement, then method 400 may return to step 408. If there are no more user-generated comments 142 that lack a paired advertisement, then method 400 may proceed to step 420.

At 420, method 400 may determine which of the paired advertisements 102 to provide to discussion webpage 104. As noted above, the evaluation may take into account information about user 10 from webpage data 116, information from comment space 136, such as whether user 10 has previously posted in comment space 136 and the number of named entities, and information about each user-generated comment 142 previously selected for potential advertisement placement. At step 422, serve application 128 may serve selected paired advertisement 102 into discussion webpage 104 for viewing user 10. To achieve this, paired advertisement 102 may be located in their predetermined advertisement positions 156 to be adjacent to a user-generated comment 142 within text space 140. Typically, paired advertisement 102 and discussion webpage 104 may be timed to come together for display shortly after user 10 requests discussion webpage 104. System 100 may select advertisements 102 at runtime with information from comment metadata 204 and webpage data 16. From step 422, method 400 may return to step 402.

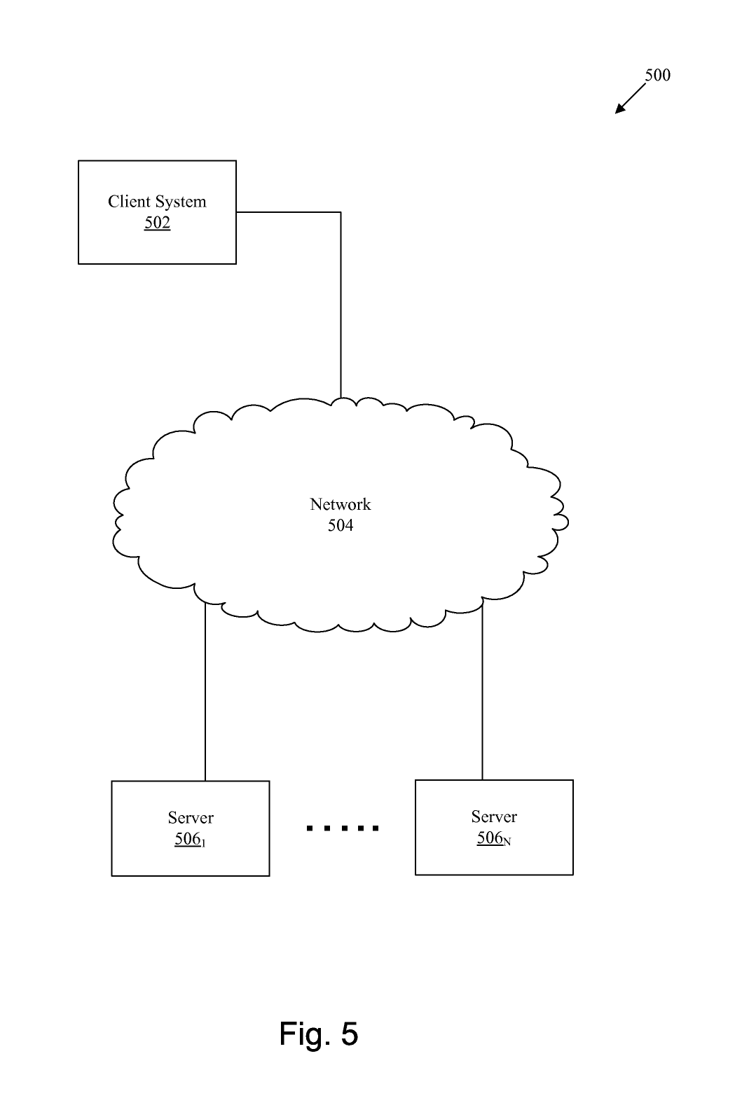

FIG. 5 illustrates a network environment 500 for operation of system 100. The network environment 500 may include a client system 502 coupled to a network 504 (such as the Internet, an intranet, an extranet, a virtual private network, a non-TCP/IP based network, any LAN or WAN, or the like) and server systems 506₁ to 506_{N}. A server system may include a single server computer or a number of server computers. Client system 502 may be configured to communicate with any of server systems 506₁ to 506_{N}, for example, to request and receive base content and additional content (e.g., in the form of photographs).

Client system 502 may include a desktop personal computer, workstation, laptop, PDA, cell phone, any wireless application protocol (WAP) enabled device, or any other device capable of communicating directly or indirectly to a network. Client system 502 typically may run a web-browsing program that may allow a user of client system 502 to request and receive content from server systems 506₁ to 506_{N} over network 504. Client system 502 may include one or more user interface devices (such as a keyboard, a mouse, a roller ball, a touch screen, a pen or the like) to interact with a graphical user interface (GUI) of the web browser on a display (e.g., monitor screen, LCD display, etc.).

In some embodiments, client system 502 and/or system servers 506₁ to 506_{N} may be configured to perform the methods described herein. The methods of some embodiments may be implemented in software or hardware configured to optimize the selection of additional content to be displayed to a user. In one example, client system 502 and/or system servers 506, to 506_{N} may include or be part of ad server 110.

System 100 may monetize user-generated comments 142 on third-party discussion webpages 104. System 100 may provide small, contextually relevant advertisements 102 automatically alongside specific (preferably high-traffic) user-generated comments 142. By tracking user click-through and impression rates, ad revenues may be accrued and divided between an ad service provider operating ad server 110 and the owner of the discussion site controlled by web server 106. All parties involved may benefit from this configuration—advertisers 130 may reach more customers 10, website owners 106 may gain an additional revenue stream, ad service provider 110 may profit, and users 10 may be provided with unobtrusive offers specifically targeted to the topic at hand.

System 100 includes features that may avoid requiring large-scale changes on the part of advertisers 130 and users 10. Moreover, after registering with ad server 110, the owners of web server 106 need only modify their site to utilize API 184. Going forward, ad server 110 may automatically match an advertisement 102 contextually to a user-generated comment 142 and determine whether to display that advertisement 102 aside the selected user-generated comment 142 or to display a different advertisement 102 aside a different user-generated comment 142. As users 10 click on paired advertisement 190 and/or paired advertisement 192, advertisers 130 may be billed for the incoming traffic and a portion of the proceeds may be awarded to the third-party site owners of web server 106.

The present invention may be implemented as a computer program product on a storage medium having instructions stored thereon/in which can be used to control, or cause, a computer to perform any of the processes of the present invention. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium, the present invention includes software for controlling both the hardware of the general purpose/specialized computer or microprocessor, and for enabling the computer or microprocessor to interact with a human consumer or other mechanism utilizing the results of the present invention. Such software may include without limitation device drivers, operating systems, and user applications. Ultimately, such computer readable medium further includes software for performing the present invention, as described above.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to display an online advertisement to a user, the method comprising:
comparing data to at least two online advertisements, where the data includes data from a user-generated comment;
selecting one of the at least two online advertisements for display with the user-generated comment, where the selected advertisement is a paired advertisement; and
serving the paired advertisement to the user-generated comment.

2. The method of claim 1, further comprising:
determining whether a user-generated comment is suitable for pairing with an online advertisement by using a weighted value for the user-generated comment.

3. The method of claim 2, further comprising:
if the user-generated comment is suitable for pairing with an online advertisement, then extracting comment metadata from the user-generated comment.

4. The method of claim 3, where the data includes data from a plurality of user-generated comments, where each user-generated comment that is suitable for pairing with an online advertisement is associated with a comment metadata, the method further comprising:
for each comment metadata, determining the paired advertisement to be served to its associated user-generated comment by comparing the data to at least two of the online advertisements; and
excluding at least one of the paired advertisements from being served to its associated user-generated comment.

5. The method of claim 1, where the data from the user-generated comment includes metadata.

6. The method of claim 1, where serving the paired advertisement to the user-generated comment includes placing the paired advertisement adjacent to the user-generated comment within a text space, where the text space is part of a discussion webpage.

7. The method of claim 6, where the text space includes a comment space containing the user-generated comment and includes an advertising space containing the paired advertisement, where a remainder of the discussion webpage is outside of the text space.

8. The method of claim 7, where the data includes data from a plurality of user-generated comments, where each user-generated comment is defined by a comment height and is associated with one advertisement position, where each advertisement position is located in the advertising space and is defined by an advertisement space height, where each advertisement space height is a function of the comment height associated with that advertisement space height, and where serving the paired advertisement to the user-generated comment includes serving at least two paired advertisements to the user-generated comment.

9. A computer readable medium comprising a set of instructions which, when executed by a computer, cause the computer to display an online advertisement to a user, the instructions for:
comparing data to at least two online advertisements, where the data includes data from a user-generated comment;
selecting one of the at least two online advertisements for display with the user-generated comment, where the selected advertisement is a paired advertisement; and
serving the paired advertisement to the user-generated comment.

10. The computer readable medium of claim 9, further comprising:
determining whether a user-generated comment is suitable for pairing with an online advertisement by using a weighted value for the user-generated comment.

11. The computer readable medium of claim 10, further comprising:
if the user-generated comment is suitable for pairing with an online advertisement, extracting comment metadata from the user-generated comment.

12. The computer readable medium of claim 11, where the data includes data from a plurality of user-generated comments, where each user-generated comment that is suitable for pairing with an online advertisement is associated with a comment metadata, the method further comprising:
for each comment metadata, determining the paired advertisement to be served to its associated user-generated comment by comparing the compiled metadata to at least two of the online advertisements; and
excluding at least one of the paired advertisements from being served to its associated user-generated comment.

13. The computer readable medium of claim 9, where the data from the user-generated comment includes metadata.

14. The computer readable medium of claim 9, where serving the paired advertisement to the user-generated comment includes preparing instructions configured to place the paired advertisement adjacent to the user-generated comment within a text space, where the text space is part of a discussion webpage.

15. The computer readable medium of claim 14, where the text space includes a comment space containing the user-generated comment and includes an advertising space containing the paired advertisement, where a remainder of the discussion webpage is outside of the text space.

16. The computer readable medium of claim 15, where the data includes data from a plurality of user-generated comments, where each user-generated comment is defined by a comment height and is associated with one advertisement position, where each advertisement position is located in the advertising space and is defined by an advertisement space height, where each advertisement space height is a function of the comment height associated with that advertisement space height, and where serving the paired advertisement to the user-generated comment includes serving at least two paired advertisements to the user-generated comment.

17. An ad server to display an online advertisement to a user, the ad server comprising:
an analyzer having software to compare data to at least two online advertisements, where the data includes data from a user-generated comment, where the analyzer further includes software to select one of the at least two online advertisements for display with the user-generated comment, where the selected advertisement is a paired advertisement; and
a serve application having software to serve the paired advertisement to the user-generated comment.

18. The ad server of claim 17, where the analyzer includes a device to determine whether a user-generated comment is suitable for pairing with an online advertisement by using a weighted value for the user-generated comment.

19. The ad server of claim 17, where a serve application includes software to serve at least two paired advertisement to the user-generated comment, the ad server further comprising:
an application program interface having written instructions which, when executed by a computer, cause the computer to capture user-generated comments, to send the captured user-generated comments to the ad server, and to serve a paired advertisement to a user-generated comment.

20. An advertising system for an Internet discussion forum having a discussion webpage, the discussion webpage comprising:
a text space controlled by a content management system;
a user-generated comment positioned within the text space; and
an online advertisement positioned next to the user-generated comment within text space as a result of being served to the user-generated comment.

21. The discussion webpage of claim 20, where the advertisement is positioned within a height of the user-generated comment.

22. The discussion webpage of claim 20, where the user-generated comment includes comment metadata and the online advertisement is produced by comparing the comment metadata from the user-generated comment to advertisements in an ad database.

23. The discussion webpage of claim 20, where the content management system lacks direct control of those areas of the discussion webpage outside of the text space.

24. The discussion webpage of claim 20, where the online advertisement is a first online advertisement, the discussion webpage further comprising:
at least a second online advertisement positioned next to the user-generated comment within text space as a result of being served to the user-generated comment.
